(19) United States
(12) Patent Application Publication
(10) Pub. No.: US 2013/0045419 A1
(43) Pub. Date: Feb. 21, 2013

(54) NEGATIVE ACTIVE MATERIAL FOR RECHARGEABLE LITHIUM BATTERY, NEGATIVE ELECTRODE INCLUDING THE SAME AND METHOD OF PREPARING THE SAME, AND RECHARGEABLE LITHIUM BATTERY INCLUDING THE SAME

(71) Applicants: Hee-Joon Chun, Yongin-si (KR); Tae-Gon Kim, Yongin-si (KR); Joon-Sup Kim, Yongin-si (KR); Wan-Uk Choi, Yongin-si (KR); Hisaki Tarui, Yongin-si (KR); Jea-Woan Lee, Yongin-si (KR); Jae-Yul Ryu, Yongin-si (KR); Chang-Keun Back, Yongin-si (KR); Young-Chang Lim, Yongin-si (KR); Seung-Hee Park, Yongin-si (KR)

(72) Inventors: Hee-Joon Chun, Yongin-si (KR); Tae-Gon Kim, Yongin-si (KR); Joon-Sup Kim, Yongin-si (KR); Wan-Uk Choi, Yongin-si (KR); Hisaki Tarui, Yongin-si (KR); Jea-Woan Lee, Yongin-si (KR); Jae-Yul Ryu, Yongin-si (KR); Chang-Keun Back, Yongin-si (KR); Young-Chang Lim, Yongin-si (KR); Seung-Hee Park, Yongin-si (KR)

(21) Appl. No.: 13/330,600

(22) Filed: Dec. 19, 2011

Related U.S. Application Data
(60) Provisional application No. 61/523,770, filed on Aug. 15, 2011.

(51) Int. Cl. H01M 4/134; C01B 33/113; H01M 4/48; H01M 4/62; H01M 4/1395

(52) U.S. Cl. 429/217; 429/218.1; 29/623.5; 252/182.1; 423/325

(57) ABSTRACT

Provided are a negative active material for a rechargeable lithium battery, which includes a first silicon oxide (SiOₓ) and a second silicon oxide (SiOₓ) with a particle diameter differing from the one of the first silicon oxide (SiOₓ), a negative electrode including the negative active material, and a method of manufacturing the negative electrode, and a rechargeable lithium battery including the negative electrode. The first silicon oxide (SiOₓ) and second silicon oxide (SiOₓ) have a particle distribution peak area ratio ranging from 3 to 8.

### BACKGROUND

1. Field

This disclosure relates to a negative active material for a rechargeable lithium battery, a negative electrode including the same, a method of preparing the same, and a rechargeable lithium battery including the same.

2. Description of the Related Art

A lithium rechargeable battery has recently drawn attention as a power source for a small portable electronic device. It uses an organic electrolyte solution and thereby has twice the discharge voltage of a conventional battery using an alkali aqueous solution and as a result, has high energy density.

This rechargeable lithium battery is used by injecting an electrolyte into a battery cell including a positive electrode including a positive active material that can intercalate and deintercalate lithium and a negative electrode including a negative active material that can intercalate and deintercalate lithium.

However, a silicon-based material used as a negative active material has a crystalline structure change when it absorbs and stores lithium and thus, a volume expansion problem. The volume change of the negative active material causes a crack on the active material particles and thus, breaks them down or brings about their contact defect and the like with a current collector. As a result, a lithium rechargeable battery has a shorter charge discharge cycle-life.

Accordingly, silicon oxide is actively researched. The silicon oxide is reported to be less expanded than silicon during a battery reaction and to bring about stable cycle-life.

However, the silicon oxide still brings about insufficient stable cycle-life due to inherently low conductivity and a small specific surface area and expansion/contraction during the charge and discharge.

### SUMMARY

One embodiment provides a negative active material for a rechargeable lithium battery by preventing volume change of a battery during the charge and discharge to improve cycle-life characteristic of the battery.

Another embodiment provides a negative electrode including the negative active material.

Yet another embodiment provides a method of preparing the negative electrode.

Still another embodiment provides a rechargeable lithium battery including the negative electrode.

According to one embodiment, provided is a negative active material for a rechargeable lithium battery, which includes a first silicon oxide (SiOₓ); and a second silicon oxide (SiOₓ) with different particle diameters from the first silicon oxide (SiOₓ) and has a particle distribution peak area ratio of the first silicon oxide (SiOₓ) relative to the second silicon oxide (SiOₓ) in a range of 3 to 8.

The particle distribution peak area ratio of the first silicon oxide (SiOₓ) relative the second silicon oxide (SiOₓ) may be in a range of 3.5 to 6.

A particle diameter ratio of the first silicon oxide (SiOₓ) relative to the second silicon oxide (SiOₓ) may be in a range of 1 to 100, and the first silicon oxide (SiOₓ) has a particle diameter (D90) ranging from 6 to 50 um, while the second silicon oxide (SiOₓ) has a particle diameter (D90) ranging from 0.5 to 5 um.

The first silicon oxide (SiOₓ) relative to the second silicon oxide (SiOₓ) has a weight ratio ranging from 1.8 to 19. The negative active material may include the first silicon oxide (SiOₓ) in an amount ranging from 65 to 95 wt % and the second silicon oxide (SiOₓ) in an amount ranging from 5 to 35 wt %.

The second silicon oxide (SiOₓ) relative to the first silicon oxide (SiOₓ) may have a specific surface area ratio ranging from 2 to 50. The first silicon oxide (SiOₓ) may have a specific surface area ranging from 1 to 5 m²/g, while the second silicon oxide (SiOₓ) has a specific surface area ranging from 10 to 50 m²/g.

The negative active material has a specific surface area ranging from 7 to 11.5 m²/g.

The first silicon oxide (SiOₓ) may have electrical conductivity ranging from 1.0×10⁻² to 1.0×10⁰ S/m, while the second silicon oxide (SiOₓ) has electrical conductivity ranging from 1.0×10 to 1.0×10³ S/m.

The negative active material may have electrical conductivity ranging from 1.0×10⁰ to 1.0×10² S/m.

The negative active material may further include a coating layer coated on at least one surface of the first silicon oxide (SiOₓ), the second silicon oxide (SiOₓ), and the negative active material. The coating layer may include at least one selected from a carbon-based material, a metal, and a combination thereof.

According to another embodiment, provided is a negative electrode for rechargeable lithium battery that includes a current collector; and a negative active material layer disposed on the current collector, wherein the negative active material layer includes a negative active material layer composition including the negative active material and a binder.

The binder may include one selected from polyimide, polyamide, polyamideimide, aramid, polyarylate, polymethylethylketone, polyetherimide, polyethersulfone, polysulfone, polyphenylene sulfide, polytetrafluoroethylene, polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polyvinylidene fluoride, polyethylene, polypropylene, styrene-butadiene rubber, acrylated styrene-butadiene rubber, an epoxy resin, nylon, and a combination thereof.

The binder may be included in an amount of 1 to 30 wt % based on the entire amount of the negative active material layer composition and in particular, in an amount of 5 to 15 wt %.

According to another embodiment, provided is a method of preparing a negative electrode for a rechargeable lithium battery that includes preparing a negative active material layer composition by mixing a first silicon oxide (SiOₓ), a second silicon oxide (SiOₓ) with different particle diameters from the first silicon oxide (SiOₓ), and a binder; and coating the negative active material layer composition on a current collector. Herein, the first silicon oxide (SiOₓ) relative to the second silicon oxide (SiOₓ) may have a particle distribution peak area ratio ranging from 3 to 8.

The first silicon oxide (SiOₓ) may have a particle diameter (D90) ranging from 6 to 50 um, while the second silicon oxide (SiOₓ) may have a particle diameter (D90) ranging from 0.5 to 5 um.

The first silicon oxide (SiOₓ) may be included in an amount ranging from 65 to 95 wt % based on the total weight of the first silicon oxide (SiOₓ) and the second silicon oxide (SiOₓ), while the second silicon oxide (SiOₓ) may be included in an amount ranging from 5 to 35 wt % based on the total weight of the first silicon oxide (SiOₓ) and the second silicon oxide (SiOₓ).

The first silicon oxide (SiOₓ) may have a specific surface area ranging from 1 to 5 m²/g, and the second silicon oxide (SiOₓ) may have a specific surface area ranging from 10 to 50 m²/g.

The first silicon oxide (SiOₓ) may have electrical conductivity ranging from 1.0×10⁻² to 1.0×10⁰ S/m, and the second silicon oxide (SiOₓ) may have electrical conductivity ranging from 1.0×10 to 1.0×10³ S/m.

The negative active material layer composition may further include at least one selected from a carbon-based material, a metal, and a combination thereof.

Another embodiment provides a rechargeable lithium battery including a positive electrode; the negative electrode; and an electrolyte solution.

Hereinafter, further embodiments will be described in detail.

The present invention may realize a rechargeable lithium battery with improved cycle-life characteristic by preventing volume change of the rechargeable lithium battery during the charge and discharge.

### BRIEF DESCRIPTION OF THE DRAWINGS

FIG. 1 is a schematic diagram showing the structure of a rechargeable lithium battery according to one embodiment.

FIGS. 2 to 4 are the diameter distribution graph of each negative active material according to Examples 1 and 6 and Comparative Example 3.

### DETAILED DESCRIPTION

Exemplary embodiments of this disclosure will hereinafter be described in detail. However, these embodiments are only exemplary, and this disclosure is not limited thereto.

According to one embodiment, a negative active material for a rechargeable lithium battery may include two silicon oxides (SiOₓ) with different particle diameters and in particular, a mixture of the first and second silicon oxides (SiOₓ) with different particle diameters.

Both of the first and second silicon oxides (SiOₓ) may all have amorphous SiOₓ particles or a composite in which SiO is dispersed inside a SiO₂ particle.

Closely examining each particle, the first silicon oxide (SiOₓ) may have a particle diameter (D90) ranging from 6 to 50 um and in particular, from 10 to 20 um. In addition, the second silicon oxide (SiOₓ) may have a smaller particle diameter (D90) than the first silicon oxide (SiOₓ) and in particular, a particle diameter (D90) ranging from 0.5 to 5 um and in more particular, from 1 to 3 um. In addition, the first silicon oxide (SiOₓ) relative to the second silicon oxide (SiOₓ) may have a particle diameter ratio ranging from 1 to 100 and in particular, from 3.5 to 20. When two silicon oxides (SiOₓ) respectively having different particle diameters or a particle diameter ratio within the range are mixed, the smaller particles exist among the larger particles, which may prevent disruption of a conductive path according to expansion and contraction during the charge and discharge and thus, realize a rechargeable lithium battery with excellent cycle-life characteristic.

The particle diameter (D90) corresponds to 90 volume % of a cumulative volume in a diameter distribution.

The first silicon oxide (SiOₓ) may be included in an amount of 65 to 95 wt % based on the entire weight of the first silicon oxide (SiOₓ) and the second silicon oxide (SiOₓ) and in particular, in an amount of 75 to 85 wt %. In addition, the second silicon oxide (SiOₓ) may be included in an amount of 5 to 35 wt % based on the entire weight of the first silicon oxide (SiOₓ) and the second silicon oxide (SiOₓ) and in particular, in an amount of 15 to 25 wt %. Furthermore, the first silicon oxide (SiOₓ) relative to the second silicon oxide (SiOₓ) may have a weight ratio ranging from 1.8 to 19 and in particular, 3 to 6. When two different silicon oxides (SiOₓ) respectively having different particle diameters or a particle diameter ratio within the range are mixed, a negative active material may not have deteriorated initial capacity during the charge and discharge but maintain mass density, which may not deteriorate impregnation of an electrolyte solution and thus, realize excellent cycle-life characteristic of a battery.

According to one embodiment, a negative active material for a rechargeable lithium battery may be prepared by mixing two silicon oxides (SiOₓ) with different specific surface areas

The specific surface area may be measured in a BET method.

As for each particle, the first silicon oxide (SiOₓ) may have a specific surface area ranging from 1 to 5 m²/g and in particular, from 2 to 4 m²/g. When the first silicon oxide (SiOₓ) has a specific surface area within the range, it may maintain initial capacity of a battery with almost no volume change during the charge and discharge and thus, maintain excellent cycle-life characteristic of the battery.

In addition, the second silicon oxide (SiOₓ) may have a specific surface area ranging from 10 to 50 m²/g and in particular, from 20 to 45 m²/g. When the second silicon oxide (SiOₓ) has a specific surface area within the range, the mixture with the first silicon oxide (SiOₓ) may have large interaction with a binder, which may prevent division of a conductive path due to expansion and contraction of a larger particle, that is, the first silicon oxide (SiOₓ) and also, deterioration of cycle-life characteristics due to expansion and contraction of a smaller particle, that is, the second silicon oxide (SiOₓ).

In addition, the second silicon oxide (SiOₓ) relative to the first silicon oxide (SiOₓ) may have a specific surface area ratio ranging from 2 to 50 and in particular, from 5 to 22.5. When two different silicon oxides (SiOₓ) with a specific surface area ratio within the range are mixed, a rechargeable lithium battery may have excellent cycle-life characteristic.

According to one embodiment, a negative active material for a rechargeable lithium battery may be prepared by mixing two kinds of silicon oxide (SiOₓ) with different electrical conductivity.

As for each particle, the first silicon oxide (SiOₓ) may have electrical conductivity ranging from 1.0×10⁻² to 1.0×10⁰ S/m and in particular, from 5.0×10⁻² to 5.0×10⁻¹ S/m. When the first silicon oxide (SiOₓ) has electrical conductivity within the range, a lithium rechargeable battery may maintain excellent cycle-life characteristic.

In addition, the second silicon oxide (SiOₓ) may have electrical conductivity ranging from 1.0×10 to 1.0×10³ S/m and in particular, from 5.0×10 to 5.0×10² S/m. When the second silicon oxide (SiOₓ) has electrical conductivity within the range, the mixture with the first silicon oxide (SiOₓ) may have large interaction with a binder, which may prevent division of a conductive path due to expansion and contraction of a larger particle, that is, the first silicon oxide (SiOₓ) and also, deterioration of cycle-life characteristic due to expansion and contraction of a smaller particle, that is, the second silicon oxide (SiOₓ).

The negative active material may further include a coating layer coated on the surface of at least one selected from the first silicon oxide (SiOₓ), the second silicon oxide (SiOₓ), and the negative active material.

The coating layer may be formed of one material selected from a carbon-based material, a metal, and a combination thereof.

The carbon-based material may include natural graphite, artificial graphite, carbon black, acetylene black, ketjen black, an amorphous carbon fine powder, a coke powder, mesophase carbon, a vapor grown carbon fiber, a pitch base carbon fiber, a polyacrylonitrile-based carbon fiber, or a combination thereof, or a carbonization product from a precursor of sucrose, a phenol resin, a naphthalene resin, polyvinyl alcohol, a furfuryl alcohol resin, a polyacrylonitrile resin, a polyamide resin, a furan resin, a cellulose resin, a styrene resin, a polyimide resin, an epoxy resin, a vinyl chloride resin, citric acid, stearic acid, polyfluorovinylidene, carboxylmethylcellulose (CMC), hydroxypropylcellulose, polyvinylpyrrolidone, tetrafluoroethylene, polyethylene, polypropylene, ethylene-propylene-diene monomer (EPDM), sulfonated EPDM, starch, glucose, gelatin, sugars, coal pitch, petroleum pitch, polyvinylchloride, mesophase pitch, tar, low molecular weight heavy oil, or a combination thereof.

The metal may be selected from Al, Ti, Fe, Ni, Cu, Zn, Ag, Sn, and a combination thereof, and a powder-shaped or fiber-shaped metal.

As aforementioned, a negative active material prepared by mixing two silicon oxides (SiOₓ) with different particle diameters, different specific surface areas, different electrical conductivity, and the like may be measured regarding diameter distribution in a laser diffraction light scattering diameter distribution measurement method.

In particular, the first silicon oxide (SiOₓ) relative to the second silicon oxide (SiOₓ) may have a particle distribution peak area ratio ranging from 3 to 8 and in particular, from 3.5 to 6. When the particle distribution peak area ratio is within the range, a rechargeable lithium battery may have excellent cycle-life characteristic. The reason is that a particulate, the second silicon oxide (SiOₓ), has maximum interaction with a binder and connects the first silicon oxide (SiOₓ) particles and resultantly, prevents division of a conductive path due to expansion and contraction of the first silicon oxide (SiOₓ).

In addition, a negative active material according to one embodiment may have a specific surface area ranging from 7 to 11.5 m²/g and in particular, from 8 to 11 m²/g. When the negative active material has a specific surface area within the range, a rechargeable lithium battery may have excellent cycle-life characteristics.

Furthermore, the negative active material may have electrical conductivity ranging from 1.0×10⁰ to 1.0×10² S/m and in particular, from 9.0×10⁰ to 9.0×10 S/m. When the negative active material has electrical conductivity within the range, a rechargeable lithium battery may have excellent cycle-life characteristic.

According to another embodiment, a negative electrode for a rechargeable lithium battery including the negative active material is provided.

The negative electrode includes a negative current collector and a negative active material layer disposed on the negative current collector, and the negative active material layer includes the negative active material and binder.

The binder improves binding properties of the negative active material particles to each other and to a current collector, and may be an organic binder and an aqueous binder. Examples of the binder may include polyimide, polyamide, polyamideimide, aramid, polyarylate, polymethylethylketone, polyetherimide, polyethersulfone, polysulfone, polyphenylene sulfide, polytetrafluoroethylene, polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polyvinylidene fluoride, polyethylene, polypropylene, styrene-butadiene rubber, an acrylated styrene-butadiene rubber, an epoxy resin, nylon, and the like, but are not limited thereto.

The binder may be included in an amount of 1 to 30 wt % based on the entire weight of the negative active material layer composition and in particular, from 5 to 15 wt %. When the binder is included within the range, the binder may bind particles and thus, provide the structure of a negative active material with stability. The structural stability may remarkably improve excellent cycle-life of a battery.

The negative active material layer may selectively include a conductive material.

Any electrically conductive material may be used as a conductive material unless it causes a chemical change. Examples of the conductive material include a carbon-based material such as natural graphite, artificial graphite, carbon black, acetylene black, ketjen black, a carbon fiber, and the like; a metal-based material such as a metal powder or a metal fiber including copper, nickel, aluminum, silver, and the like; a conductive polymer such as a polyphenylene derivative; a mixture thereof.

According to another embodiment, a method of preparing a negative electrode for a rechargeable lithium battery including the negative active material is provided.

The negative electrode may be prepared by mixing the first silicon oxide (SiOₓ), the second silicon oxide (SiOₓ) and the binder in a solvent to prepare a negative active material layer composition, and coating the negative active material layer composition on a current collector.

The solvent may be N-methylpyrrolidone, but it is not limited thereto.

The first silicon oxide (SiOₓ) and the second silicon oxide (SiOₓ) used to prepare the negative electrode may be respectively the same as illustrated above. As aforementioned, the first silicon oxide (SiOₓ) and the second silicon oxide (SiOₓ) may have a particle diameter, a specific surface area, electrical conductivity, and the like with respectively different ranges.

The first silicon oxide (SiOₓ) may be included in an amount of 65 to 95 wt % based on the entire weight of the first silicon oxide (SiOₓ) and the second silicon oxide (SiOₓ) and in particular, 75 to 85 wt %. In addition, the second silicon oxide (SiOₓ) may be included in an amount of 5 to 35 wt % based on the entire weight of the first silicon oxide (SiOₓ) and the second silicon oxide (SiOₓ)) and in particular, 15 to 25 wt %. When the first and second silicon oxides (SiOₓ) are respectively included within the range, a negative active material may not decrease initial capacity during the charge and discharge of lithium ions but maintain mass density, thus, not deteriorate impregnation of an electrolyte solution, and resultantly, realize excellent cycle-life characteristic of a battery.

The negative active material layer composition may be prepared by further including one selected from a carbon-based material, a metal, and a combination thereof and accordingly, forming a coating layer on at least one surface of the first silicon oxide (SiOₓ) and the second silicon oxide (SiOₓ).

The negative active material layer may further include a conductive material.

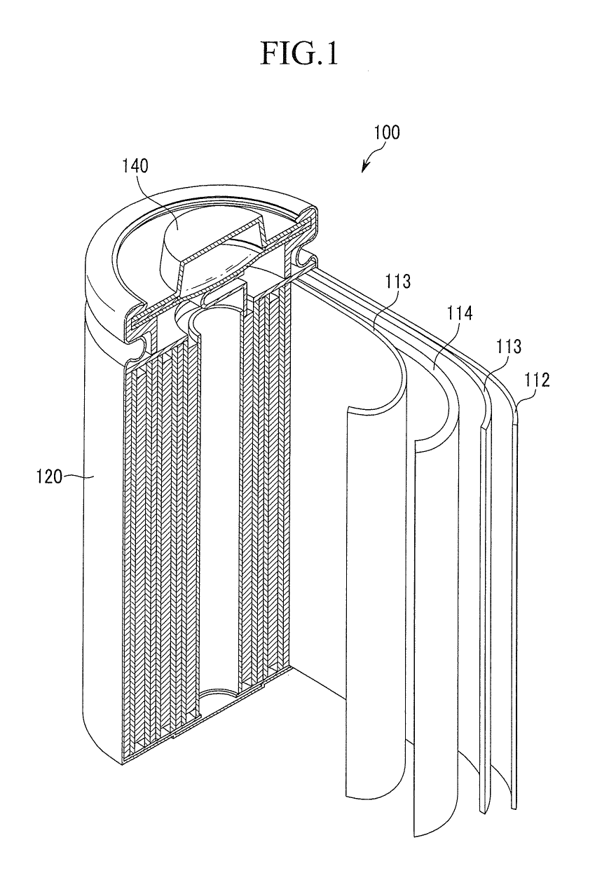

According to another embodiment, provided is a rechargeable lithium battery including the negative electrode. The rechargeable lithium battery is illustrated referring to FIG. 1.

FIG. 1 is the schematic view of a rechargeable lithium battery according to one embodiment.

Referring to FIG. 1, a rechargeable lithium battery 100 according to one embodiment includes a battery cell including a positive electrode 114, a negative electrode 112 facing the positive electrode 114, a separator 113 interposed between the positive electrode 114 and negative electrode 112, and an electrolyte (not shown) impregnating the positive electrode 114, negative electrode 112, and separator 113, a battery case 120 housing the battery cell, and a sealing member 140 sealing the battery case 120.

The negative electrode 112 is the same as described above.

The positive electrode 114 may include a current collector and a positive active material layer on the current collector. The positive active material layer may include a positive active material, a binder, and selectively, a conductive material.

The current collector may be Al but is not limited thereto.

The positive active material includes a lithiated intercalation compound that reversibly intercalates and deintercalates lithium ions. The positive active material may include a composite oxide including at least one selected from the group consisting of cobalt, manganese, and nickel, as well as lithium. In particular, the following lithium-containing compounds may be used:

LiₐA_{1-b}B_{b}D₂ (wherein, in the above formula, 0.90≦a≦1.8 and 0≦b≦0.5); LiₐE_{1-b}B_{b}O_{2-c}D_{c} (wherein, in the above formula, 0.90≦a≦1.8, 0≦b≦0.5, 0≦c≦0.05); LiE_{2-b}B_{b}O_{4-c}D_{c} (wherein, in the above formula, 0≦b≦0.5, 0≦c≦0.05); LiₐNi_{1-b-c}Co_{b}B_{c}D_{α} (wherein, in the above formula, 0.90≦a≦1.8, 0≦b≦0.5, 0≦c≦0.05, 0<α≦2); LiₐNi_{1-b-c}Co_{b}B_{c}O_{2-α}F_{α} (wherein, in the above formula, 0.90≦a≦1.8, 0≦b≦0.5, 0≦c≦0.05, 0<α<2); LiₐNi_{1-b-c}Co_{b}B_{c}O_{2-α}F₂ (wherein, in the above formula, 0.90≦a≦1.8, 0≦b≦0.5, 0≦c≦0.05, 0<α<2); LiₐNi_{1-b-c}Mn_{b}B_{c}D_{α} (wherein, in the above formula, 0.90≦a≦1.8, 0≦b≦0.5, 0≦c≦0.05, 0<α≦2); LiₐNi_{1-b-c}Mn_{b}B_{c}O_{2-α}F_{α} (wherein, in the above formula, 0.90≦a≦1.8, 0≦b≦0.5, 0≦c≦0.05, 0<α<2); LiₐNi_{1-b-c}Mn_{b}B_{c}O_{2-α}F₂ (wherein, in the above formula, 0.90≦a≦1.8, 0≦b≦0.5, 0≦c≦0.05, 0<α<2); LiₐNi_{b}E_{c}G_{d}O₂ (wherein, in the above formula, 0.90≦a≦1.8, 0≦b≦0.9, 0≦c≦0.5, 0.001≦d≦0.1); LiₐNi_{b}Co_{c}Mn_{d}GeO₂ (wherein, in the above formula, 0.90≦a≦1.8, 0≦b≦0.9, 0≦c≦0.5, 0≦d≦0.5, 0.001≦e≦0.1); LiₐNiG_{b}O₂ (wherein, in the above formula, 0.90≦a≦1.8, 0.001≦b≦0.1); LiₐCoG_{b}O₂ (wherein, in the above formula, 0.90≦a≦1.8, 0.001≦b≦0.1); LiₐMnG_{b}O₂ (wherein, in the above formula, 0.90≦a≦1.8, 0.001≦b≦0.1); LiₐMn₂G_{b}O₄ (wherein, in the above formula, 0.90≦a≦1.8, 0.001≦b≦0.1); QO₂; QS₂; LiQS₂; V₂O₅; LiV₂O₅; LiIO₂; LiNiVO₄; Li_{(3-f)}J₂(PO₄)₃(0≦f≦2); Li_{(3-f)}Fe₂(PO₄)₃(0≦f≦2); and LiFePO₄.

In the above formulas, A is selected from Ni, Co, Mn, or a combination thereof; B is selected from Al, Ni, Co, Mn, Cr, Fe, Mg, Sr, V, a rare earth element, or a combination thereof; D is selected from O, F, S, P, or a combination thereof; E is selected from Co, Mn, or a combination thereof; F is selected from F, S, P, or a combination thereof; G is selected from Al, Cr, Mn, Fe, Mg, La, Ce, Sr, V, or a combination thereof; Q is selected from Ti, Mo, Mn, or a combination thereof; I is selected from Cr, V, Fe, Sc, Y, or a combination thereof; and J is selected from V, Cr, Mn, Co, Ni, Cu, or a combination thereof.

The compound may have a coating layer on the surface, or may be mixed with another compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxylcarbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive active material by using these elements in the compound. For example, the method may include any coating method such as spray coating, dipping, and the like, but is not illustrated in more detail since it is well-known to those who work in the related field.

The binder improves binding properties of the positive active material particles to each other and to a current collector. Examples of the binder include polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

Any electrically conductive material may be used as a conductive material unless it causes a chemical change. Examples of the conductive material include: one or more of natural graphite, artificial graphite, carbon black, acetylene black, ketjen black, a carbon fiber, copper, a metal powder or a metal fiber including nickel, aluminum, silver, and the like, and a polyphenylene derivative.

The positive electrode 114 may be provided by mixing an active material, a conductive material, and a binder in a solvent to prepare an active material composition, and coating the composition on a current collector.

The electrode manufacturing method is well known, and thus is not described in detail in the present specification. The solvent may be N-methylpyrrolidone, but it is not limited thereto.

The electrolyte solution includes a lithium salt and a non-aqueous organic solvent.

The non-aqueous organic solvent serves as a medium for transmitting ions taking part in the electrochemical reaction of a battery. The non-aqueous organic solvent may include a carbonate-based, ester-based, ether-based, ketone-based, alcohol-based, or aprotic solvent.

Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), propylene carbonate (PC), butylene carbonate (BC), or the like.

When the carbonate-based solvent is prepared by mixing a cyclic carbonate and a linear carbonate, a solvent having a low viscosity while having an increased dielectric constant may be provided. The cyclic carbonate and the chain carbonate are mixed together in the volume ratio of 1:1 to 1:9.

Examples of the ester-based solvent may include methyl acetate, ethyl acetate, n-propyl acetate, dimethylacetate, methylpropionate, ethylpropionate, γ-butyrolactone, decanolide, valerolactone, mevalonolactone, caprolactone, or the like. Examples of the ether-based solvent include dibutyl ether, tetraglyme, diglyme, dimethoxyethane, 2-methyltetrahydrofuran, tetrahydrofuran, or the like, and examples of the ketone-based solvent include cyclohexanone, or the like. Examples of the alcohol-based solvent include ethyl alcohol, isopropyl alcohol.

The non-aqueous organic solvent may be used singularly or in a mixture. When the organic solvent is used in a mixture, the mixture ratio can be controlled in accordance with a desirable battery performance.

The non-aqueous electrolyte may further include an overcharge-inhibiting additive such as ethylenecarbonate, pyrocarbonate, and like.

The lithium salt is dissolved in an organic solvent and plays a role of supplying lithium ions in a battery, operating a basic operation of the rechargeable lithium battery, and improving lithium ion transportation between positive and negative electrodes therein.

Examples of the lithium salt include at least one of LiPF₆, LiBF₄, LiSbF₆, LiAsF₆, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (x and y are natural numbers), LiCl, LiI, LiB(C₂O₄)₂ (lithium bis(oxalato) borate; LiBOB), or a combination thereof.

The lithium salt may be used in a concentration ranging from about 0.1 M to about 2.0 M. When the lithium salt is included at the above concentration range, an electrolyte may have excellent performance and lithium ion mobility due to optimal electrolyte conductivity and viscosity.

The separator 113 may be a single layer or a multi-layer, and made of for example polyethylene, polypropylene, polyvinylidene fluoride, or a combination thereof.

Hereinafter, the embodiments are illustrated in more detail with reference to examples. However, the following are exemplary embodiments and are not limiting.

Furthermore, what is not described in this specification can be sufficiently understood by those who have knowledge in this field and will not be illustrated here.

### Example 1

72 wt % of a first silicon oxide powder (A) (based on the entire weight of a negative active material) with a particle diameter (D90) of 11.4 um, a specific surface area of 3.2 m²/g, and electrical conductivity of 6.5×10⁻² S/m was mixed with 18 wt % of a second silicon oxide powder (B) (based on the entire weight of a negative active material) with a particle diameter (D90) of 2.1 um, a specific surface area of 39.2 m²/g, and electrical conductivity of 10×10 S/m. Next, 10 wt % of polyimide (based on the entire weight of a negative active material) was added to the mixture, and N-methylpyrrolidone was added thereto, preparing negative active material layer composition in a slurry status. The negative active material layer composition was coated on a 15 μm-thick copper foil, compressed with a press roller, and vacuum-dried at 110° C. for 2 hours. The dried substrate was cut to have a size of 1.33 cm², fabricating a negative electrode.

The negative electrode was used with a metal lithium as a counter electrode, fabricating a coin-type half-cell. Herein, an electrolyte solution was prepared by mixing ethylenecarbonate (EC), ethylmethylcarbonate (EMC), and diethylcarbonate (DEC) in a volume ratio of 3:2:5 to prepare a mixed solution including 0.2 volume % of LiBF₄ and 5 volume % of fluoro ethylenecarbonate (FEC) and dissolving 1.15M LiPF₆ therein.

### Example 2

A half-cell was fabricated according to the same method as Example 1 except for using a second silicon oxide powder (B) with a particle diameter (D90) of 2.3 um, a specific surface area of 30.7 m²/g, and electrical conductivity of 5.3×10 S/m instead of the second silicon oxide powder (B).

### Example 3

A half-cell was fabricated according to the same method as Example 1 except for using a second silicon oxide powder (B) with a particle diameter (D90) of 1.5 um, a specific surface area of 42.3 m²/g, and electrical conductivity of 3.1×10² S/m instead of the second silicon oxide powder (B).

### Example 4

A half-cell was fabricated according to the same method as Example 1 except for using a second silicon oxide powder (B) with a particle diameter (D90) of 2.9 um, a specific surface area of 24.3 m²/g, and electrical conductivity of 5.02×10 S/m instead of the second silicon oxide powder (B).

### Example 5

A half-cell was fabricated according to the same method as Example 1 except for using a mixture of 72 wt % of a first silicon oxide powder (A) (based on the entire weight of a negative active material) with a particle diameter (D90) of 15.1 um, a specific surface area of 2.32 m²/g, and electrical conductivity of 3.5×10⁻² S/m and 18 wt % of the second silicon oxide powder (B) (based on the entire weight of a negative active material) with a particle diameter (D90) of 2.3 um, a specific surface area of 30.7 m²/g, and electrical conductivity of 5.3×10 S/m.

### Example 6

A half-cell was fabricated according to the same method as Example 1 except for using a mixture of 72 wt % of a first silicon oxide powder (A) (based on the entire weight of a negative active material) with a particle diameter (D90) of 19.6 um, a specific surface area of 2.10 m²/g, and electrical conductivity of 1.2×10⁻² S/m and 18 wt % of the second silicon oxide powder (B) (based on the entire weight of a negative active material) with a particle diameter (D90) of 2.3 um, a specific surface area of 30.7 m²/g, and electrical conductivity of 5.3×10 S/m.

### Comparative Example 1

A half-cell was fabricated according to the same method as Example 1 except for using a second silicon oxide powder (B) with a particle diameter (D90) of 5.4 um, a specific surface area of 3.3 m²/g, and electrical conductivity of 8.9×10⁻⁷ S/m instead of the second silicon oxide powder (B).

### Comparative Example 2

A half-cell was fabricated according to the same method as Example 1 except for using a second silicon oxide powder (B) with a particle diameter (D90) of 8.1 um, a specific surface area of 2.8 m²/g, and electrical conductivity of 8.8×10⁻⁷ S/m instead of the second silicon oxide powder (B).

### Comparative Example 3

A half-cell was fabricated according to the same method as Example 1 except for using a mixture of 72 wt % of a first silicon oxide powder (A) (based on the entire weight of a negative active material) with a particle diameter (D90) of 31.9 um, a specific surface area of 0.2 m²/g, and electrical conductivity of 2.6×10⁻⁷ S/m and 18 wt % of the second silicon oxide powder (B) (based on the entire weight of a negative active material) with a particle diameter (D90) of 2.3 um, a specific surface area of 30.7 m²/g, and electrical conductivity of 5.3×10 S/m.

### Comparative Example 4

A half-cell was fabricated according to the same method as Example 1 except for using a mixture of 72 wt % of a first silicon oxide powder (A) (based on the entire weight of a negative active material) with a particle diameter (D90) of 55.3 um, a specific surface area of 0.08 m²/g, and electrical conductivity of 1.3×10⁻⁷ S/m and 18 wt % of the second silicon oxide powder (B) (based on the entire weight of a negative active material) with a particle diameter (D90) of 2.3 um, a specific surface area of 30.7 m²/g, and electrical conductivity of 5.3×10 S/m.

### Comparative Example 5

A half-cell was fabricated according to the same method as Example 1 except for using no second silicon oxide powder (B).

### Comparative Example 6

A half-cell was fabricated according to the same method as Example 1 except for using no second silicon oxide powder (B).

The first silicon oxide powders (A) and the second silicon oxide powders (B) according to Examples 1 to 6 and Comparative Examples 1 to 6 were provided regarding features in the following Table 1.

TABLE 1

| | | Examples | | | | | |
|---|---|---|---|---|---|---|---|
| | | 1 | 2 | 3 | 4 | 5 | 6 |
| First | Particle | 11.4 | 11.4 | 11.4 | 11.4 | 15.1 | 19.6 |
| silicon | diameter | | | | | | |
| oxide | (um) | | | | | | |
| (A) | Specific | 3.2 | 3.2 | 3.2 | 3.2 | 2.32 | 2.10 |
| | surface | | | | | | |
| | area | | | | | | |
| | (m²/g) | | | | | | |
| | Electrical | 6.5 × 10⁻² | 6.5 × 10⁻² | 6.5 × 10⁻² | 6.5 × 10⁻² | 3.5 × 10⁻² | 1.2 × 10⁻² |
| | conductivity | | | | | | |
| | (S/m) | | | | | | |
| Second | Particle | 2.1 | 2.3 | 1.5 | 2.9 | 2.3 | 2.3 |
| silicon | diameter | | | | | | |
| oxide | (um) | | | | | | |
| (B) | Specific | 39.2 | 30.7 | 42.3 | 24.3 | 30.7 | 30.7 |
| | surface | | | | | | |
| | area | | | | | | |
| | (m²/g) | | | | | | |
| | Electrical | 10 × 10 | 5.3 × 10 | 3.1 × 10² | 5.02 × 10 | 5.3 × 10 | 5.3 × 10 |
| | conductivity | | | | | | |
| | (S/m) | | | | | | |

| | | | | | | |
|---|---|---|---|---|---|---|
| Particle diameter | 5.43 | 4.96 | 7.6 | 3.93 | 6.57 | 8.52 |
| ratio (A/B) | | | | | | |
| Specific surface | 12.25 | 9.59 | 13.22 | 7.59 | 13.23 | 14.62 |
| area ratio (B/A) | | | | | | |

| | | Comparative Examples | | | | | |
|---|---|---|---|---|---|---|---|
| | | 1 | 2 | 3 | 4 | 5 | 6 |
| First | Particle | 11.4 | 11.4 | 31.9 | 55.3 | 11.4 | — |
| silicon | diameter | | | | | | |
| oxide | (um) | | | | | | |
| (A) | Specific | 3.2 | 3.2 | 0.2 | 0.08 | 3.2 | — |
| | surface | | | | | | |
| | area | | | | | | |
| | (m²/g) | | | | | | |
| | Electrical | 6.5 × 10⁻² | 6.5 × 10⁻² | 2.6 × 10⁻⁷ | 1.3 × 10⁻⁷ | 6.5 × 10⁻² | — |
| | conductivity | | | | | | |
| | (S/m) | | | | | | |
| Second | Particle | 5.4 | 8.1 | 2.3 | 2.3 | — | 2.1 |
| silicon | diameter | | | | | | |
| oxide | (um) | | | | | | |
| (B) | Specific | 9.3 | 7.8 | 30.7 | 30.7 | — | 39.2 |
| | surface | | | | | | |
| | area | | | | | | |
| | (m²/g) | | | | | | |
| | Electrical | 8.9 × 10⁻¹ | 8.8 × 10⁻¹ | 5.3 × 10 | 5.3 × 10 | — | 10 × 10 |
| | conductivity | | | | | | |
| | (S/m) | | | | | | |

| | | | | | | |
|---|---|---|---|---|---|---|
| Particle diameter | 2.11 | 1.41 | 13.87 | 24.04 | — | — |
| ratio (A/B) | | | | | | |
| Specific surface | 2.91 | 2.44 | 153.5 | 383.75 | — | — |
| area ratio (B/A) | | | | | | |

Evaluation 1: Particle Distribution Graph Analysis of Negative Active Material

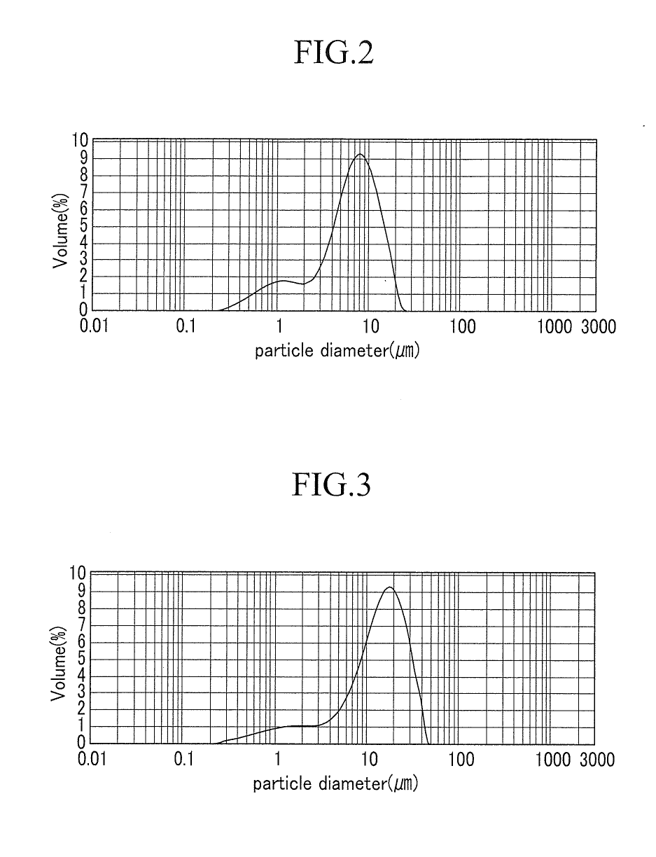

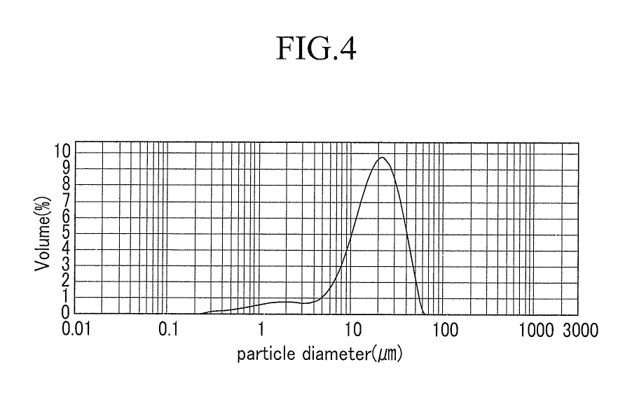

The negative active materials according to Examples 1 to 6 and Comparative Examples 1 to 6 were measured regarding particle diameter distribution in a laser diffraction scattering diameter distribution measurement method. The results are provided in FIGS. 2 to 4. Table 2 shows an area ratio A/B of particle distribution peaks.

TABLE 2

| | Examples | | | | | | Comparative Examples | | | | | |
|---|---|---|---|---|---|---|---|---|---|---|---|---|
| | 1 | 2 | 3 | 4 | 5 | 6 | 1 | 2 | 3 | 4 | 5 | 6 |
| Area | 4.89 | 3.12 | 5.32 | 3.02 | 6.53 | 7.85 | 2.79 | 1.56 | 15.33 | 21.56 | — | — |
| ratio | | | | | | | | | | | | |
| (A/B) of | | | | | | | | | | | | |
| particle | | | | | | | | | | | | |
| distribution | | | | | | | | | | | | |
| peak | | | | | | | | | | | | |

FIGS. 2 to 4 are the diameter distribution graph of the negative active materials according to each Examples 1 and 6 and Comparative Example 3.

Referring to FIGS. 2 to 4 and Table 2, an area ratio of the particle distribution peaks of the first silicon oxide (SiOₓ) relative to the second silicon oxide (SiOₓ) in Examples 1 to 6 is in a range of 3 to 8.

Evaluation 2: Specific Surface Area Analysis of Negative Active Material

The negative active materials according to Examples 1 to 6 and Comparative Examples 1 to 6 were measured regarding specific surface area in a BET method. The results are provided in the following Table 3.

TABLE 3

| | Examples | | | | | | Comparative Examples | | | | | |
|---|---|---|---|---|---|---|---|---|---|---|---|---|
| | 1 | 2 | 3 | 4 | 5 | 6 | 1 | 2 | 3 | 4 | 5 | 6 |
| Specific | 10.4 | 8.7 | 11.02 | 7.42 | 7.996 | 7.82 | 4.42 | 4.12 | 6.3 | 6.204 | — | — |
| surface | | | | | | | | | | | | |
| area | | | | | | | | | | | | |
| (m²/g) of | | | | | | | | | | | | |
| negative | | | | | | | | | | | | |
| active | | | | | | | | | | | | |
| material | | | | | | | | | | | | |

Referring to Table 3, the negative active materials according to Examples 1 to 6 had an optimal specific surface area ranging from 7 to 11.5 m²/g.

Evaluation 3: Electrical Conductivity Analysis of Negative Active Material

The negative active materials according to Examples 1 to 6 and Comparative Examples 1 to 6 were regarding electrical conductivity in a 4 pin probe powder resistance measurement method. The results are provided in the following Table 4.

TABLE 4

| | Examples | | | | | | Comparative Examples | | | | | |
|---|---|---|---|---|---|---|---|---|---|---|---|---|
| | 1 | 2 | 3 | 4 | 5 | 6 | 1 | 2 | 3 | 4 | 5 | 6 |
| Electrical | 3.2 × 10¹ | 9.7 × 10⁰ | 8.9 × 10¹ | 7.5 × 10⁰ | 4.2 × 10⁰ | 1.3 × 10⁰ | 9.6 × 10⁻² | 7.9 × 10⁻² | 5.3 × 10⁻³ | 2.8 × 10⁻³ | — | — |
| conductivity (S/m) | | | | | | | | | | | | |
| of negative | | | | | | | | | | | | |
| active | | | | | | | | | | | | |
| material | | | | | | | | | | | | |

Referring to Table 4, the negative active materials according to Examples 1 to 6 has optimal electrical conductivity ranging from 1.0×10⁰ to 1.0×10² S/m.

Evaluation 4: Charge and Discharge Characteristics of Rechargeable Lithium Battery Cell

The rechargeable lithium battery cells according to Examples 1 to 6 and Comparative Examples 1 to 6 were measured regarding charge and discharge characteristic. The results are provided in the following Table 5.

The charge was performed up to 0.005V with 0.05 C (1 C=1200 mAh) in a CC mode.

The initial efficiency (%) was calculated as a percentage of initial discharge capacity relative to initial charge capacity.

The capacity retention (%) was calculated as a percentage of discharge capacity at the 50th cycle relative to initial discharge capacity.

TABLE 5

| | | Initial | | |
|---|---|---|---|---|
| | Initial charge | discharge | Initial | Capacity |
| | capacity | capacity | efficiency | retention (%) |
| | (mAh/g) | (mAh/g) | (%) | (50 cycle) |
| Example 1 | 2481 | 1846 | 74.4 | 90.3 |
| Example 2 | 2423 | 1796 | 74.1 | 88.1 |
| Example 3 | 2456 | 1815 | 73.9 | 92.4 |
| Example 4 | 2417 | 1789 | 74.0 | 85.6 |
| Example 5 | 2391 | 1741 | 72.8 | 84.2 |
| Example 6 | 2354 | 1697 | 72.1 | 83.6 |
| Comparative | 2381 | 1741 | 73.1 | 78.4 |
| Example 1 | | | | |
| Comparative | 2411 | 1767 | 73.3 | 65.4 |
| Example 2 | | | | |
| Comparative | 1759 | 1181 | 67.1 | 51.8 |
| Example 3 | | | | |
| Comparative | 1817 | 1274 | 70.1 | 70.7 |
| Example 4 | | | | |
| Comparative | 2331 | 1660 | 71.2 | 58.2 |
| Example 5 | | | | |
| Comparative | 2122 | 1470 | 69.3 | 63.8 |
| Example 6 | | | | |

Referring to Table 5, the cells according to Examples 1 to 6 had excellent cycle-life characteristic compared with the cells according to Comparative Examples 1 to 6.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

100: rechargeable lithium battery
112: negative electrode
113: separator
114: positive electrode
120: battery case
140: sealing member

What is claimed is:

1. A negative active material for a rechargeable lithium battery, the negative active material comprising:
a first silicon oxide (SiOₓ); and
a second silicon oxide (SiOₓ) differing in particle diameters from the first silicon oxide (SiOₓ),
wherein a particle distribution peak area ratio of the first silicon oxide (SiOₓ) relative to the second silicon oxide (SiOₓ) is in a range of 3 to 8.

2. The negative active material of claim 1, wherein the particle distribution peak area ratio of the first silicon oxide (SiOₓ) relative the second silicon oxide (SiOₓ) is in a range of 3.5 to 6.

3. The negative active material of claim 1, wherein a particle diameter (D90) ratio of the first silicon oxide (SiOₓ) relative to the second silicon oxide (SiOₓ) is in a range of 1.2 to 100.

4. The negative active material of claim 1, wherein the first silicon oxide (SiOₓ) has a particle diameter (D90) in a range of 6 to 50 um, and the second silicon oxide (SiOₓ) has a particle diameter (D90) in a range of 0.5 to 5 um.

5. The negative active material of claim 1, wherein a weight ratio of the first silicon oxide (SiOₓ) relative to the second silicon oxide (SiOₓ) is in a range of 1.8 to 19.

6. The negative active material of claim 1, wherein the first silicon oxide (SiOₓ) is included in an amount of 65 to 95 wt % based on the entire weight of the first silicon oxide (SiOₓ) and the second silicon oxide (SiOₓ), and the second silicon oxide (SiOₓ) is included in an amount of 5 to 35 wt % based on the entire weight of the first silicon oxide (SiOₓ) and the second silicon oxide (SiOₓ).

7. The negative active material of claim 1, wherein a specific surface area ratio of the second silicon oxide (SiOₓ) relative to the first silicon oxide (SiOₓ) is in a range of 2 to 50.

8. The negative active material of claim 1, wherein the first silicon oxide (SiOₓ) has a specific surface area in a range of 1 to 5 m²/g, and the second silicon oxide (SiOₓ) has a specific surface area in a range of 10 to 50 m²/g.

9. The negative active material of claim 1, wherein the negative active material has a specific surface area in a range of 7 to 11.5 m²/g.

10. The negative active material of claim 1, wherein the first silicon oxide (SiOₓ) has an electrical conductivity in a range of 1.0×10⁻² to 1.0×10⁰ S/m, and the second silicon oxide (SiOₓ) has an electrical conductivity in a range of 1.0×10 to 1.0×10³ S/m.

11. The negative active material of claim 1, wherein the negative active material has an electrical conductivity in a range of 1.0×10⁰ to 1.0×10²S/m.

12. The negative active material of claim 1, further comprising a coating layer coated on at least one surface of the first silicon oxide (SiOₓ), the second silicon oxide (SiOₓ), or both the first silicon oxide (SiOₓ) and the second silicon oxide (SiOₓ).

13. The negative active material of claim 12, wherein the coating layer comprises a material selected from the group consisting of carbon-based materials, metals, and combinations thereof.

14. A rechargeable lithium battery comprising:
a positive electrode;
a negative electrode comprising:
a current collector; and
a negative active material layer on the current collector; and
an electrolyte solution impregnating the positive electrode and the negative electrode,
wherein the negative active material layer comprises a negative active material layer composition, the negative active material layer composition comprises the negative active material of claim 1 and a binder.

15. The rechargeable lithium battery of claim 14, wherein the binder comprises a material selected from the group consisting of polyimides, polyamides, polyamideimides, aramids, polyarylates, polymethylethylketones, polyetherimides, polyethersulfones, polysulfones, polyphenylene sulfides, polytetrafluoroethylenes, polyvinylalcohols, carboxylmethylcelluloses, hydroxypropylcelluloses, polyvinylchlorides, carboxylated polyvinylchlorides, polyvinylfluorides, ethylene oxide-containing polymers, polyvinylpyrrolidones, polyurethanes, polyvinylidene fluorides, polyethylenes, polypropylenes, styrene-butadiene rubbers, acrylated styrene-butadiene rubbers, epoxy resins, nylons, and combinations thereof.

16. The rechargeable lithium battery of claim 14, wherein the binder is included in an amount of 1 to 30 wt % based on the entire amount of the negative active material layer composition.

17. The rechargeable lithium battery of claim 16, wherein the binder is included in the amount of 5 to 15 wt % based on the entire amount of the negative active material layer composition.

18. The rechargeable lithium battery of claim 14, wherein the negative active material layer composition further comprises a coating layer coated on at least one surface of the first silicon oxide (SiOₓ), the second silicon oxide (SiOₓ), or both the first silicon oxide (SiOₓ) and the second silicon oxide (SiOₓ), and the coating layer comprises a material selected from the group consisting of carbon-based materials, metals, and combinations thereof.

19. The rechargeable lithium battery of claim 14, wherein the first silicon oxide (SiOₓ) is included in an amount of 65 to 95 wt % based on the entire weight of the first silicon oxide (SiOₓ) and the second silicon oxide (SiOₓ), and the second silicon oxide (SiOₓ) is included in an amount of 5 to 35 wt % based on the entire weight of the first silicon oxide (SiOₓ) and the second silicon oxide (SiOₓ).

20. A method of preparing a negative electrode for a rechargeable lithium battery, the method comprising:
preparing a negative active material layer composition by mixing together a first silicon oxide (SiOₓ), a second silicon oxide (SiOₓ) having different particle diameters from the first silicon oxide (SiOₓ), and a binder; and
coating the negative active material layer composition on a current collector,
wherein a particle distribution peak area ratio of the first silicon oxide (SiOₓ) relative to the second silicon oxide (SiOₓ) is in a range of 3 to 8.
